(19) United States
(12) Patent Application Publication
(10) Pub. No.: US 2010/0088866 A1
(43) Pub. Date: Apr. 15, 2010

(54) CASKET

(76) Inventors: Tony C. Fifer, Angola, IN (US); Troy T. Hantz, Angola, IN (US); Randy S. Smith, Waterloo, IN (US)

Correspondence Address: TAYLOR & AUST, P.C., P.O. Box 560, 142. S Main Street, Avilla, IN, 46710, US

(21) Appl. No.: 12/248,243

(22) Filed: Oct. 9, 2008

(51) Int. Cl. A61G 17/00; A61G 17/013; A61G 17/007

(52) U.S. Cl. 27/4

(57) ABSTRACT

A casket includes a lid and a tub detachably coupled with the lid. The tub includes a plurality of walls and a first plurality of hook-and-loop fasteners, the plurality of walls being folded relative to one another and detachably coupled together using the first plurality of hook-and-loop fasteners.

### BACKGROUND OF THE INVENTION

1. Field of the Invention

The present invention relates to caskets, and, more particularly, to corrugated caskets.

2. Description of the Related Art

Corrugated fiberboard containers such as boxes have been proposed for use and holding deceased human beings. Such containers can be used as cremation boxes and can be held together using cutouts and openings and without the use of fasteners. While this design can be useful, a more secure design may be desired. A rental casket system is known which has a removable end piece attached to a rim of the casket using VELCRO® and which uses a tie wrap to join a side wall to an end wall. A coffin is known which has an inside upholstering fixed to the coffin using a VELCRO® strip. Each of these designs suffers from complexity, expense, lack of desired security, and/or lack of desired speed in assembling the overall structure.

What is needed in the art is a casket which can be made inexpensively and assembled easily, speedily, and securely.

### SUMMARY OF THE INVENTION

The present invention provides a casket which can be made inexpensively and assembled easily, speedily, and securely.

The invention in one form is directed to a casket which includes a lid and a tub detachably coupled with the lid. The tub includes a plurality of walls and a first plurality of hook-and-loop fasteners, the plurality of walls being folded relative to one another and detachably coupled together using the first plurality of hook-and-loop fasteners.

The invention in another form is directed to a blank assembly for forming a portion of a casket. The blank assembly includes a blank including a plurality of walls. The first plurality of hook-and-loop fasteners are coupled with corresponding ones of the plurality of walls, the plurality of walls being configured for folding relative to one another and for detachably coupling together using the first plurality of hook-and-loop fasteners and thereby for forming the blank assembly into a tub of the casket.

The invention in yet another form is directed to a method of making a casket, the method including the steps of: providing a lid, a blank, and a first plurality of hook-and-loop fasteners, the blank including a plurality of walls; coupling the first plurality of hook-and-loop fasteners with corresponding ones of the plurality of walls; folding the plurality of walls relative to one another; coupling detachably the plurality of walls together using the first plurality of hook-and-loop fasteners; forming a tub at least in part from the blank and the first plurality of hook-and-loop fasteners; and coupling detachably the lid with the tub.

An advantage of the present invention is that it provides a casket (which can be used as a cremation casket or a burial casket) with a tub and a lid, the tub and the lid being held to one another solely using hook-and-loop fasteners.

Another advantage is that it provides a casket tub formed from a single piece of fiberboard, such as cardboard.

Yet another advantage is that it provides a casket tub which can be shipped as a single-piece blank and subsequently assembled easily and speedily.

Yet another advantage is that it provides a casket tub which is held together solely using hook-and-loop fasteners.

Yet another advantage is that a deceased human being can be easily located in the interior of the tub of the casket after detaching the respective hook-and-loop fasteners and dropping down either one of the longitudinal side walls of the tub or one of the transverse end walls of the tub, thereby obviating the need to lift the deceased up and over upstanding walls of the tub.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective view of the casket according to the present invention;

FIG. 2 is a perspective view of the lid of the casket of FIG. 1;

FIG. 3 is a top plan view of a blank used in forming the tub of the casket of FIG. 1;

FIG. 4 is perspective view of a partially assembled tub of the casket of FIG. 1; and

FIG. 5 is a perspective view of the tub of the casket of FIG. 1 in an open position to permit side insertion of a human body into the casket.

Corresponding reference characters indicate corresponding parts throughout the several views. The exemplifications set out herein illustrate one embodiment of the invention, and such exemplifications are not to be construed as limiting the scope of the invention in any manner.

### DETAILED DESCRIPTION OF THE INVENTION

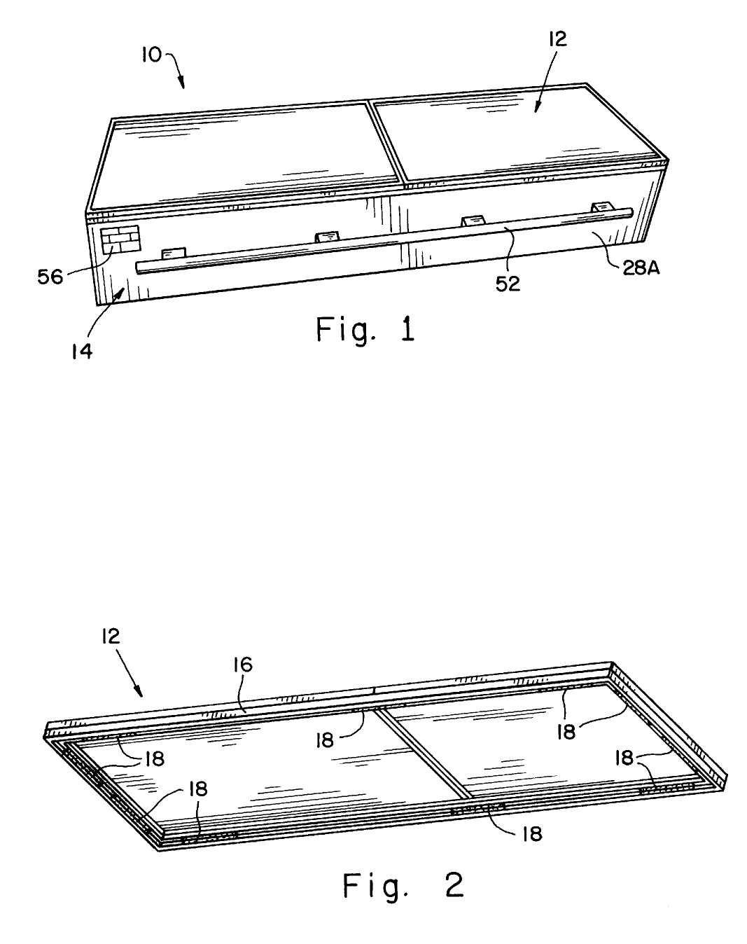

Referring now to the drawings, and more particularly to FIG. 1, there is shown a casket 10 which generally includes a lid 12 and a tub 14. Casket 10 can be used as a burial casket or, alternatively, as a cremation casket. As a burial casket, casket 10 can be used to bury a human body (not shown). As a cremation casket, casket 10 can be used to hold and transport a human body (not shown) prior to cremation. Further, as a cremation casket, casket 10, or at least tub 14, can be used to hold the body during cremation; thus, cremation casket 10, in part or in whole, can be consumed by combustion during cremation. An example of casket 10 which can be used as either a burial casket or a cremation casket is a cloth corrugated casket produced by Waterloo International Funeral Supply of Waterloo, Ind.

FIGS. 1 and 2 show lid 12. FIG. 1 shows a perspective view of the top of lid 12 as mounted on tub 14. FIG. 2 shows a perspective view of the bottom (or interior portion) of lid 12 removed from tub 14. Lid 12 can have a rectangular shape to mate with the rectangular plan view profile of tub 14. Lid 12 includes a frame 16 and a plurality of spaced apart fabric hook-and-loop fasteners 18 attached to frame 16. Frame 16 can be a wooden frame. Hook-and-loop fasteners 18 can be adhered to frame 16 and further secured to frame 16 using staples. Hook-and-loop fasteners 18 coupled to lid 12 detachably couple with a plurality of corresponding fabric hook-and-loop fasteners 20 attached to tub 14. Corresponding ones of hook-and-loop fasteners 18 and 20 mate with each other. Lid 12 detachably couples with tub 14 using hook-and-loop fasteners 18 attached to lid 12 and the mating hook-and-loop fasteners 20 attached to tub 14. Hook-and-loop fasteners 18 and 20 of lid 12 and tub 18 can be the sole way to couple lid 12 with tub 14; in at least one embodiment of the present invention, hook-and-loop fasteners 18 and 20 of lid 12 and tub 18 are the sole way of coupling lid 12 with tub 14, no other fasteners being used to couple lid 12 with tub 14. As shown in FIG. 2, two hook-and-loop fasteners 18 can be attached to each transverse side of frame 16, and three hook-and-loop fasteners 18 can be attached to each longitudinal side of frame 16; more or less hook-and-loop fasteners can be used. Hook-and-loop fasteners 18 are aligned with and mate with hook-and-loop fasteners 20. As shown in FIGS. 1 and 2, lid 12 can further include two panel sections, either (or both) of which can be secured to frame 16 using, at least in part, a hinged linkage (not shown) so that the respective panel section can be opened and, if so desired, propped open in order to view the body contained in casket 10.

The hook-and-loop fasteners referenced herein 18, 20, 42, 44 can otherwise be known as VELCRO® strips. The hook-and-loop fasteners referenced herein generally have a “hook” side, which is a piece of fabric covered with tiny hooks, and a “loop” side, which is a piece of fabric covered with loops. When the two sides are pressed together, the hooks catch in the loops and hold the two pieces together. The hook-and-loop fasteners can be made of, for example, nylon and/or polyester. Hook-and-loop fastener as used herein refers to either the hook or the loop sides. For example, it is understood that lid 12 has hook-and-loop fasteners attached thereto even if lid 12 actually only has hook sides attached thereto while tub 14 has the mating loop sides attached thereto.

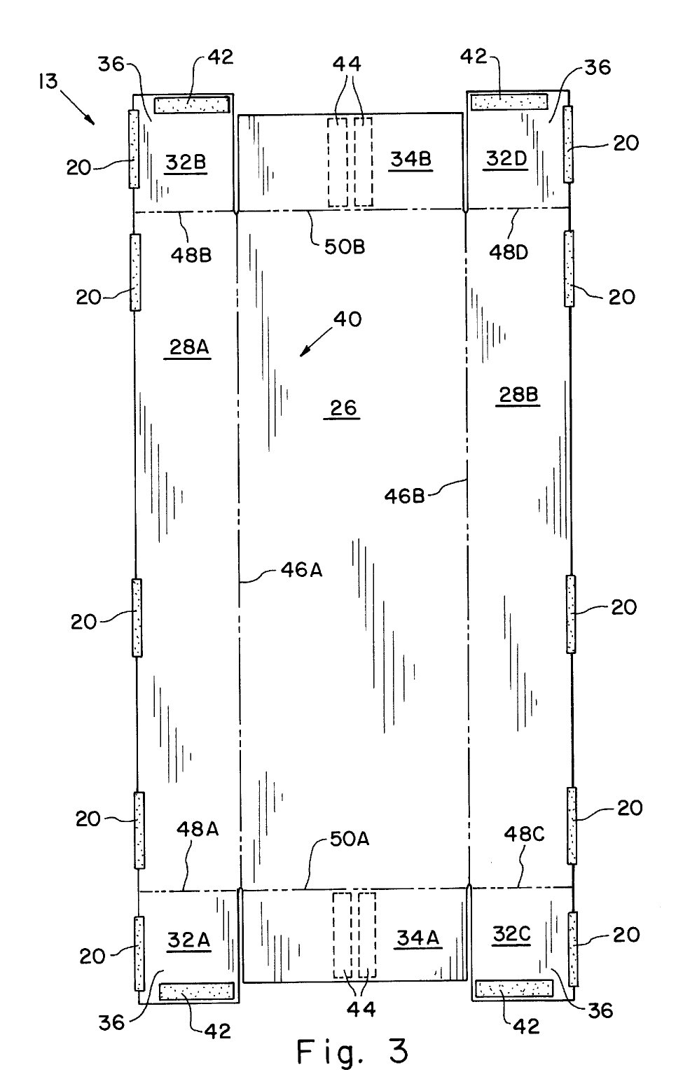

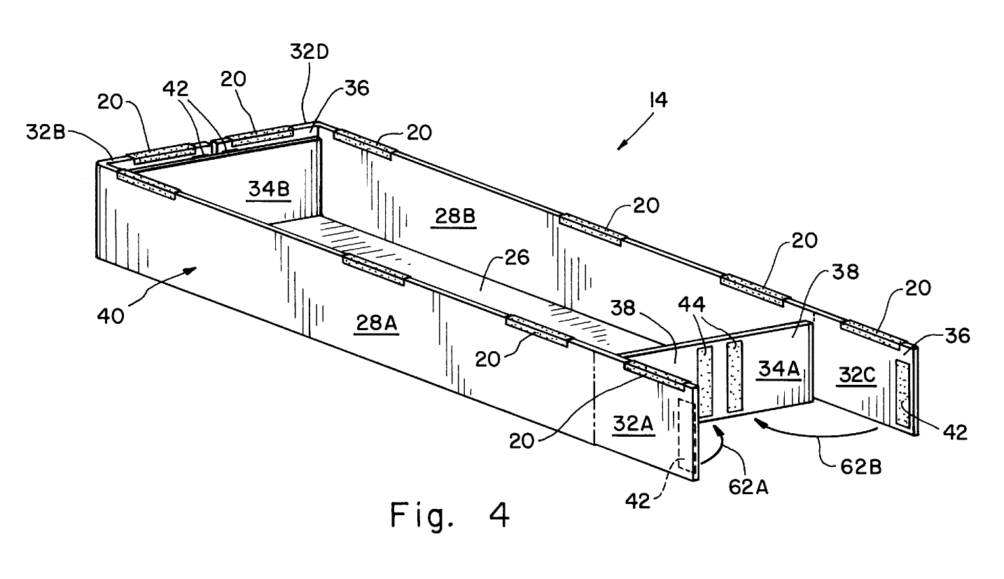

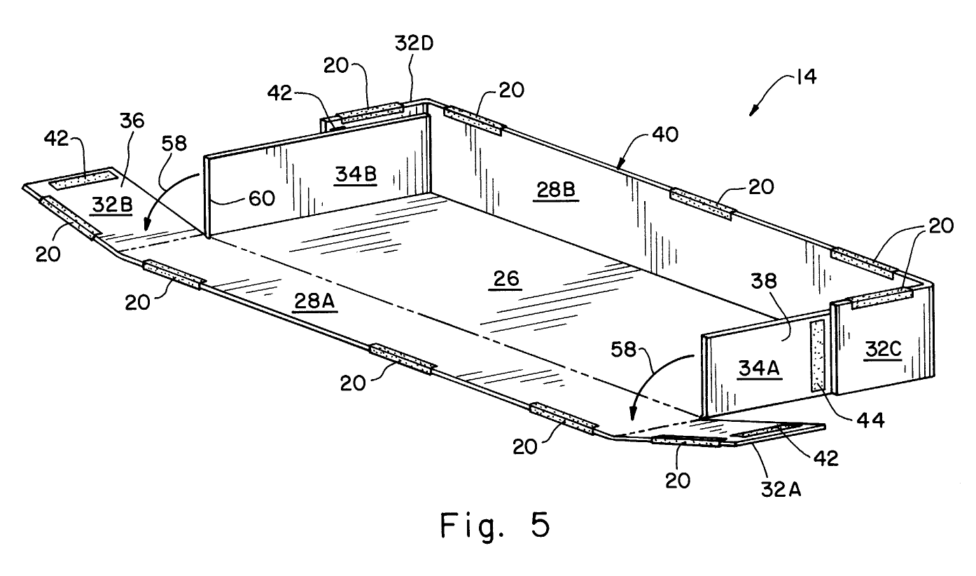

Tub 14 is detachably coupled with lid 12 using hook-and-loop fasteners 18 and 20 and is formed from a blank assembly 13. FIG. 3 shows a plan view of blank assembly 13 before blank assembly 13 is folded into tub 14. Thus, blank assembly 13 is for forming a portion of casket 10, that portion being tub 14. More specifically, tub 14 and blank assembly 13 are the same structure, but blank assembly 13 as used herein more precisely refers to tub 14 before tub 14 has been folded into a shape usable as a casket 10, whether that be the completely closed up shape of casket 10 shown in FIG. 1 or whether that be the partially closed up shape of casket 10 shown in FIG. 5 (as discussed below, FIG. 5 shows casket 10 having a side wall 28A which is dropped down in order to load more easily a human body into the interior of tub 14). For instance, FIG. 1 shows tub 14 formed from blank assembly 13. FIG. 3, on the other hand, shows a flat blank assembly 13 not yet folded to form tub 14. FIG. 4 shows a partially folded and connected blank assembly 13; for reference purposes, the partially folded and connected blank assembly 13 shown in FIG. 4 is referred to as a tub 14 considering that a body could be loaded in the disconnected end of the tub 14 shown in FIG. 4. Similarly, as tub 14 includes a body 40, including walls 26, 28A-B, 32A-D, 34A-B, and a plurality of hook-and-loop fasteners 20, 42, 44, so blank assembly 13 includes a blank 40, including walls 26, 28A-B, 32A-D, 34A-B, and a plurality of hook-and-loop fasteners 20, 42, 44.

Blank assembly 13 is symmetrical about an axis extending longitudinally in the plane of the page of FIG. 3 and centered between the longitudinal edges of bottom wall 26. Tub 14, in its completely folded and assembled state, is similarly a symmetrically shaped rectangular box without a lid 12. The generally centrally located hook-and-loop fasteners 20 on side walls 28A and 28B, however, can be generally offset toward one of the transverse ends 30, as shown in the figures (such as FIGS. 3-5).

Blank 40 includes walls 26, 28A-B, 32A-D, 34A-B. Hook-and-loop fasteners 20, 42, 44 of blank assembly 13 are attached to corresponding walls 28A-B, 32A-D, 34A-B, walls 26, 28A-B, 32A-D, 34A-B being configured for folding relative to one another and for detachably coupling together using hook-and-loop fasteners 42, 44 and thereby for forming blank assembly 13 into tub 14 of casket 10. Further, blank assembly 13 includes hook-and-loop fasteners 20 coupled with corresponding walls 28A-B, 32A-D, hook-and-loop fasteners 18 and 20 being configured for detachably coupling tub 14 with a lid 12 of casket 10. Accordingly, tub 14 includes walls 26, 28A-B, 32A-D, 34A-B and hook-and-loop fasteners 20, 42, 44, walls 26, 28A-B, 32A-D, 34A-B being folded relative to one another and detachably coupled together using hook-and-loop fasteners 42, 44. Tub 14 includes hook-and-loop fasteners 20 coupled with corresponding walls 28A-B, 32A-D, lid 12 being detachably coupled with tub 14 using hook-and-loop fasteners 18 and 20.

Blank 40 is a single cardboard body 40 which includes walls 26, 28A-B, 32A-D, 34A-B. Body 40 can be folded and thus form body 40 of tub 14. As such, tub 14 includes a single cardboard body 40 which includes walls 26, 28A-B, 32A-D, 34A-B. Cardboard body 40 is a corrugated structure. Formed as tub 14, body 40 is a knock-down structure; thus, body 40 can be assembled and disassembled in use. Body 40 can include, for example, three layers of inner fluted media spaced apart by flat layers of paperboard, the inner fluted media being corrugated media; having at least one inner corrugated medium and exterior flat pieces of paperboard, body 40 can be otherwise referred to as corrugated fiberboard.

Walls 26, 28A-B, 32A-D, 34A-B of blank 40 include rectangular bottom wall 26, two oppositely facing side walls 28A and 28B each foldably connected to and extending from bottom wall 26 and each including two transverse ends 30, four attachment walls 32A, 32B, 32C, 32D each foldably connected respectively to and extending respectively from one transverse end 30, and two oppositely facing end walls 34A and 34B each foldably connected to and extending from bottom wall 26. Tub 14 includes the same walls 26, 28A-B, 32A-D, 34A-B except that walls 28A-B, 32A-D, 34A-B are upstanding when tub 14 is fully assembled. Side walls 28A-B are positioned along opposite longitudinal sides of bottom wall 26 and are substantially identical to one another. Attachment walls 32A-D are positioned along transverse sides 30 of each side wall 28A-B and are substantially identical to one another. End walls 34A-B are positioned along transverse sides of bottom wall 26 and are substantially identical to one another. Each attachment wall 32A-D includes an inside surface 36. Each end wall 34A-B includes an outside surface 38. Hook-and-loop fasteners 42 are attached respectively to inside surfaces 36 of attachment walls 32A-D, and hook-and-loop fasteners 44 are attached respectively to outside surfaces 38 of end walls 34A-B. FIG. 3 shows hook-and-loop fasteners 44 in broken lines as they are actually hidden from view because they are on outside surface 38, which faces away from the viewer in FIG. 3. Similarly, FIG. 4 shows hook-and-loop fastener 42 on wall 32A in broken lines as it is actually hidden from the viewer in FIG. 4. Regarding blank assembly 13, hook-and-loop fasteners 42 of inside surfaces 36 are configured for detachably coupling with corresponding hook-and-loop fasteners 44 of outside surfaces 38 so as to thereby detachably couple inside surfaces 36 with corresponding outside surfaces 38. Regarding tub 14, hook-and-loop fasteners 42 of inside surfaces 36 are detachably coupled with corresponding hook-and-loop fasteners 44 of outside surfaces 38 so as to thereby detachably couple inside surfaces 36 with corresponding outside surfaces 38.

Blank 40 further includes fold lines 46A, 46B, 48A, 48B, 48C, 48D, 50A, 50B. Fold lines 46A-B, 48A-D, 50A-B can be formed by deforming blank 40 by scoring, slit scoring, or otherwise. Side wall 28A and a longitudinal side of bottom wall 26 form a fold line 46A therebetween. Side wall 28B and the other longitudinal side of bottom wall 26 forms a fold line 46B therebetween. Transverse sides 30 of side walls 28A-B and corresponding attachment walls 32A-D form corresponding fold lines 48A, 48B, 48C, and 48D therebetween. Transverse sides of bottom wall 26 and end walls 34A-B form corresponding fold lines 50A and 50B therebetween.

Hook-and-loop fasteners 20, 42, 44 are strips which are adhered to various portions of blank assembly 13 and, thus, of tub 14, too. Each side wall 28A-B can include three spaced apart hook-and-loop fasteners 20 which are folded over a top surface of side walls 28A-B and thereby adhere to the top surface and to inside and outside surfaces of the side walls 28A-B. Each attachment wall 32A-D includes one hook-and-loop fastener 20 and one hook-and-loop fastener 42. Hook-and-loop fastener 20 of each attachment wall 32A-D is folded over a top surface of the respective attachment wall 32A-D and thereby adheres to the top surface and to inside and outside surfaces of the respective attachment walls 32A-D. Hook-and-loop fasteners 20 of attachment walls 32A-D align with and mate with corresponding hook-and-loop fasteners 18 of lid 12 and are thus used to attach tub 14 and lid 12 together, along with hook-and-loop fasteners 20 of side walls 28A-B. Hook-and-loop fastener 42 of each attachment wall 32A-D is, as indicated above, adhered to an inside surface 36 near the distal end of the respective attachment walls 32A-D. Each end wall 34A-B includes two hook-and-loop fasteners 44 each of which is attached, as indicated above, to an outside surface 38 of the respective end wall 34A-B. As shown in FIGS. 3-5, hook-and-loop fasteners 44 of each end wall 34A-B can be placed near the center of the respective end wall 34A-B and run parallel to each other. Accordingly, hook-and-loop fasteners 20 of each side wall 28A-B, as well as hook-and-loop fasteners 20 of each attachment wall 32A-D, are aligned with and mate with corresponding hook-and-loop fasteners 18 of lid 12. Further, hook-and-loop fasteners 42 of respective attachment walls 32A-D are aligned with and mate with corresponding hook-and-loop fasteners 44 of respective end walls 34A-B.

Regarding blank 40, side walls 28A-B, attachment walls 32A-D, and end walls 34A-B are configured for being detachably coupled together in an upstanding manner solely by way of hook-and-loop fasteners 42 and 44. Regarding tub 14, upstanding side walls 28A-B, upstanding attachment walls 32A-D, and upstanding end walls 34A-B are detachably coupled together solely by way of hook-and-loop fasteners 42 and 44. Thus, hook-and-loop fasteners 42 and 44 are the only way that walls 28A-B, 32A-D, and 34A-B stand upright and hold together as a tub 14, no other fasteners being used to hold tub 14 together. Tub 14, with hook-and-loop fasteners 42 and 44, can hold up to about 600 pounds without using additional fasteners to hold walls 26, 28A-B, 32A-D, 34A-B together.

Further, casket 10 can further include two railings 52. Each railing 52 is attached to a corresponding side wall 28A, 28B using attachment features. Railings 52 are used to carry casket 10, such as when casket 10 contains a human body therein. The attachment features are used to attach each railing 52 to side walls 28A-B. The attachment features can include, for example, a bolt or screw and a hard surface, such as a piece of wood, to prevent the bolt/screw from penetrating the cardboard of blank/body 40. One railing 52 is shown only in FIG. 1 and not the other figures, for the sake of clarity.

Optionally, tub 14 can be provided with a decorative laminate 56, which is shown schematically in FIG. 1. While FIG. 1 shows laminate 56 as a small box, it is understood that laminate 56 can be provided over all or only part of the exterior portions of tub 14 (and lid 12 as well). Laminate 56 can be provided on blank 40 before folding blank 40 into tub 14. Laminate 56, for instance, can provide casket 10 with a wood-like appearance. Laminate 56 can be a paper with adhesive on the back, the back adhering to blank/body 40. Laminate 56 can be placed on blank 40, for instance, before any of the hook-and-loop fasteners 20, 42, 44 are attached to blank 40. To provide a nice appearance, laminate 56 can wrap around and adhere to inside portions of blank 40. For instance, laminate 56 can wrap around attachment walls 32A-D and terminate on inside surface 36 of attachment walls 32A-D. Thus, hook-and-loop fasteners 42, for instance, can adhere at least in part to a portion of laminate 56; in this sense, hook-and-loop fasteners 42 are still attached to or coupled with inside surface 36. For the sake of clarity, only FIG. 1 shows laminate 56.

In use, hook-and-loop fasteners 18 are attached to lid 12, using adhesive and/or staples. Further, hook-and-loop fasteners 20 are folded over the upper surfaces of side walls 28A-B of blank 40. One hook-and-loop fastener 20 is also folded over the upper surface of each attachment wall 32A-D of blank 40. One hook-and-loop fastener 42 is attached to inside surface 36 of the distal end (the terminating end) of each attachment wall 32A-D, running generally from near the top surface to the bottom surface of attachment walls 32A-D. Further, two hook-and-loop fasteners 44 are attached to outside surfaces 38 of each end wall 34A-B, these two hook-and-loop fasteners 44 running generally parallel to one another and generally running from near the top surface to the bottom surface of end walls 34A-B. Both side wall 28A and end wall 34A are folded up to a vertical position about corresponding fold lines 46A and 50A. Attachment wall 32A of side wall 28A is then folded inwardly about fold line 48A toward end wall 34A (in the direction of arrow 62A), and hook-and-loop fastener 42 of attachment wall 32A mates with and attaches to the corresponding one of the hook-and-loop fasteners 44 of end wall 34A (the hook-and-loop fastener 44 nearest side wall 28A). Similarly, end wall 34B is folded up to a vertical position about fold line 50B. Attachment wall 32B of side wall 28A is then folded inwardly about fold line 48B toward end wall 34B, and hook-and-loop fastener 42 of attachment wall 32B mates with and attaches to the corresponding one of the hook-and-loop fasteners 44 of end wall 34B (the hook-and-loop fastener 44 nearest side wall 28A). Similarly, side wall 28B is folded up to a vertical position about fold line 46B. Attachment wall 32C of side wall 28B is then folded inwardly about fold line 48C toward end wall 34A (in the direction of arrow 62B), and hook-and-loop fastener 42 of attachment wall 32C mates with and attaches to the corresponding one of the hook-and-loop fasteners 44 of end wall 34A (the hook-and-loop fastener 44 nearest side wall 28B). Similarly, attachment wall 32D of side wall 28B is then folded inwardly about fold line 48D toward end wall 34B, and hook-and-loop fastener 42 of attachment wall 32D mates with and attaches to the corresponding one of the hook-and-loop fasteners 44 of end wall 2 (the hook-and-loop fastener 44 nearest side wall 28B). Tub 14 is now fully formed and in a final or completely folded or assembled state. Lid 12 is then placed on the top surfaces of side walls 28A-B and attachment walls 32A-D, hook-and-loop fasteners 18 of lid 12 mating with the corresponding hook-and-loop fasteners 20 of tub 14. Accordingly, only hook-and-loop fasteners hold walls 28A-B, 32A-D, 34A-B together and couple lid 12 with tub 14. No additional parts are needed to accomplish the aforedescribed folding and coupling action of the various parts of blank/body 40.

Tub 14 can take on an alternative shape from the completely folded shape, in order to more easily insert a human body inside tub 14. To take on this alternative shape, lid 12 can be removed from tub 14. Then, side wall 28A is to be dropped down, as shown in FIG. 5. To drop down side wall 28A, hook-and-loop fastener 42 of attachment wall 32A and hook-and-loop fastener 44 of end wall 34A are detached from one another, and hook-and-loop fastener 42 of attachment wall 32B and hook-and-loop fastener 44 of end wall 34B are detached from one another. Side wall 28A is then pivoted outwardly about fold line 46A, as shown by arrows 58 in FIG. 5. Upon pivoting side wall 28A outwardly to, for example, ninety degrees from vertical, an opening 60 is formed which leads into the interior of tub 14. When side wall 28A occupies this dropped-down position, a human body can be inserted through opening 60 into the interior of tub 14 without having to lift the body up and over side wall 28A. Side wall 28B does not need to be dropped down as well to insert the body inside tub 14. Thus, casket 10 is configured for receiving a body therein via opening 60 formed when side wall 28A is pivoted outwardly upon detaching attachment walls 32A and 32B from end walls 34A and 34B by detaching corresponding ones of hook-and-loop fasteners 42 and 44 while the other attachment walls 32C and 32D are still coupled to end walls 34A and 34B. Side wall 28B can just as easily be the drop-down wall, rather than side wall 28A. Alternatively, rather than dropping down side wall 28A (or side wall 28B), end wall 34A could be dropped down (90 degrees for instance) after detaching attachment walls 32A and 32C from end wall 34A; a human body could then be inserted into the opening formed by the dropping down of end wall 34A to locate the body in tub 14. It is understood that end wall 34B, rather than end wall 34A, could be dropped down in a similar manner to locate a human body inside tub 14.

The present invention further provides a method of making casket 10. The method includes the steps of: providing a lid 12, a blank 40, and hook-and-loop fasteners 42, 44, blank 40 including walls 26, 28A-B, 32A-D, 34A-B; coupling hook-and-loop fasteners 42, 44 with corresponding ones of walls 28A-B, 32A-D, 34A-B; folding walls 28A-B, 32A-D, 34A-B relative to one another; coupling detachably walls 28A-B, 32A-D, 34A-B together using hook-and-loop fasteners 42, 44; forming tub 14 at least in part from blank 40 and hook-and-loop fasteners 42, 44; and coupling detachably lid 12 with tub 14. The method further includes the steps of coupling hook-and-loop fasteners 20 with walls 28A-B, 32A-D and coupling detachably tub 14 with lid 12 using hook-and-loop fasteners 20. The method further includes the step of forming blank 40 from a single cardboard body 40 which includes walls 26, 28A-B, 32A-D, 34A-B. Walls 26, 28A-B, 32A-D, 34A-B includes rectangular bottom wall 26, two oppositely facing upstanding side walls 28A-B each foldably connected to and extending from bottom wall 26 and each including two transverse ends 30, four upstanding attachment walls 32A-D each foldably connected respectively to and extending respectively from one of the transverse ends 30, and two oppositely facing upstanding end walls 34A-B each foldably connected to and extending from bottom wall 26, upstanding side walls 28A-B, upstanding attachment walls 32A-D, and upstanding end walls 34A-B being detachably coupled together solely by way of hook-and-loop fasteners 42 and 44. Each attachment wall 32A-D includes an inside surface 36 and each end wall 34A-B includes an outside surface 38, hook-and-loop fasteners 42, 44 being coupled respectively with inside surfaces 36 of attachment walls 32A-D and outside surfaces 38 of end walls 34A-B, the method further including the step of coupling detachably inside surfaces 36 with corresponding outside surfaces 38 by coupling detachably hook-and-loop fasteners 42 of inside surfaces 36 with corresponding hook-and-loop fasteners 44 of outside surfaces 38. Side walls 28A-B include a first side wall 28A and a second side wall 28B, attachment walls 32A-D (each of which can also be referred to as flaps) foldably connected to and extending from transverse ends 30 of first side wall 28A being first attachment walls 32A-B, attachment walls 32A-D foldably connected to and extending from transverse ends 30 of second side wall 28B being second attachment walls 32C-D, pivoting first side wall 28A outwardly upon detaching first attachment walls 32A-B from end walls 34A-B by detaching corresponding ones of hook-and-loop fasteners 42, 44 when second attachment walls 32C-D are coupled to end walls 34A-B, the casket 10 being thereby configured for receiving a body therein via an opening 60 formed from the step of pivoting first side wall 28 and the corresponding attachment walls 32A-B.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A casket, comprising:
a lid;
a tub detachably coupled with said lid, said tub including a plurality of walls and a first plurality of hook-and-loop fasteners, said plurality of walls folded relative to one another and detachably coupled together using said first plurality of hook-and-loop fasteners.

2. The casket of claim 1, further comprising a second plurality of hook-and-loop fasteners coupled respectively with said lid and said tub, said lid detachably coupled with said tub using said second plurality of hook-and-loop fasteners.

3. The casket of claim 1, wherein said tub includes a single cardboard body which includes said plurality of walls.

4. The casket of claim 3, wherein said plurality of walls includes a rectangular bottom wall, two oppositely facing upstanding side walls each foldably connected to and extending from said bottom wall and each including two transverse ends, four upstanding attachment walls each foldably connected respectively to and extending respectively from one of said transverse ends, and two oppositely facing upstanding end walls each foldably connected to and extending from said bottom wall, said upstanding side walls, said upstanding attachment walls, and said upstanding end walls being detachably coupled together solely by way of said first plurality of hook-and-loop fasteners.

5. The casket of claim 4, wherein each said attachment wall includes an inside surface and each said end wall includes an outside surface, said first plurality of hook-and-loop fasteners being coupled respectively with said inside surfaces of said attachment walls and said outside surfaces of said end walls, said hook-and-loop fasteners of said inside surfaces detachably coupled with corresponding said hook-and-loop fasteners of said outside surfaces so as to thereby detachably couple said inside surfaces with corresponding said outside surfaces.

6. The casket of claim 4, wherein said side walls include a first side wall and a second side wall, said attachment walls foldably connected to and extending from said transverse ends of said first side wall being first attachment walls, said attachment walls foldably connected to and extending from said transverse ends of said second side wall being second attachment walls, the casket being configured for receiving a body therein via an opening formed when said first side wall is pivoted outwardly upon detaching said first attachment walls from said end walls by detaching corresponding ones of said first plurality of hook-and-loop fasteners when said second attachment walls are coupled to said end walls.

7. A blank assembly for forming a portion of a casket, said blank assembly comprising:
a blank including a plurality of walls; and
a first plurality of hook-and-loop fasteners coupled with corresponding ones of said plurality of walls, said plurality of walls configured for folding relative to one another and for detachably coupling together using said first plurality of hook-and-loop fasteners and thereby for forming the blank assembly into a tub of the casket.

8. The blank assembly of claim 7, further comprising a second plurality of hook-and-loop fasteners coupled with corresponding ones of said plurality of walls, said second plurality of hook-and-loop fasteners configured for detachably coupling said tub with a lid of the casket.

9. The blank assembly of claim 7, wherein said blank is a single cardboard body which includes said plurality of walls.

10. The blank assembly of claim 9, wherein said plurality of walls includes a rectangular bottom wall, two oppositely facing side walls each foldably connected to and extending from said bottom wall and each including two transverse ends, four attachment walls each foldably connected respectively to and extending respectively from one of said transverse ends, and two oppositely facing end walls each foldably connected to and extending from said bottom wall, said side walls, said attachment walls, and said end walls being configured for being detachably coupled together in an upstanding manner solely by way of said first plurality of hook-and-loop fasteners.

11. The blank assembly of claim 10, wherein each said attachment wall includes an inside surface and each said end wall includes an outside surface, said first plurality of hook-and-loop fasteners being coupled respectively with said inside surfaces of said attachment walls and said outside surfaces of said end walls, said hook-and-loop fasteners of said inside surfaces configured for detachably coupling with corresponding said hook-and-loop fasteners of said outside surfaces so as to thereby detachably couple said inside surfaces with corresponding said outside surfaces.

12. The blank assembly of claim 10, wherein said side walls include a first side wall and a second side wall, said attachment walls foldably connected to and extending from said transverse ends of said first side wall being first attachment walls, said attachment walls foldably connected to and extending from said transverse ends of said second side wall being second attachment walls, the casket being configured for receiving a body therein via an opening formed when said first side wall is pivoted outwardly upon detaching said first attachment walls from said end walls by detaching corresponding ones of said first plurality of hook-and-loop fasteners when said second attachment walls are coupled to said end walls.

13. A method of making a casket, said method comprising the steps of:
providing a lid, a blank, and a first plurality of hook-and-loop fasteners, said blank including a plurality of walls;
coupling said first plurality of hook-and-loop fasteners with corresponding ones of said plurality of walls;
folding said plurality of walls relative to one another;
coupling detachably said plurality of walls together using said first plurality of hook-and-loop fasteners;
forming a tub at least in part from said blank and said first plurality of hook-and-loop fasteners; and
coupling detachably said lid with said tub.

14. The method of claim 13, further including the steps of coupling a second plurality of hook-and-loop fasteners with corresponding ones of said plurality of walls and coupling detachably said tub with said lid using said second plurality of hook-and-loop fasteners.

15. The method of claim 13, further comprising the step of forming said blank from a single cardboard body which includes said plurality of walls.

16. The method of claim 15, wherein said plurality of walls includes a rectangular bottom wall, two oppositely facing upstanding side walls each foldably connected to and extending from said bottom wall and each including two transverse ends, four upstanding attachment walls each foldably connected respectively to and extending respectively from one of said transverse ends, and two oppositely facing upstanding end walls each foldably connected to and extending from said bottom wall, said upstanding side walls, said upstanding attachment walls, and said upstanding end walls being detachably coupled together solely by way of said first plurality of hook-and-loop fasteners.

17. The method of claim 16, wherein each said attachment wall includes an inside surface and each said end wall includes an outside surface, said first plurality of hook-and-loop fasteners being coupled respectively with said inside surfaces of said attachment walls and said outside surfaces of said end walls, the method further including the step of coupling detachably said inside surfaces with corresponding said outside surfaces by coupling detachably said hook-and-loop fasteners of said inside surfaces with corresponding said hook-and-loop fasteners of said outside surfaces.

18. The method of claim 16, wherein said side walls include a first side wall and a second side wall, said attachment walls foldably connected to and extending from said transverse ends of said first side wall being first attachment walls, said attachment walls foldably connected to and extending from said transverse ends of said second side wall being second attachment walls, pivoting said first side wall outwardly upon detaching said first attachment walls from said end walls by detaching corresponding ones of said first plurality of hook-and-loop fasteners when said second attachment walls are coupled to said end walls, the casket being thereby configured for receiving a body therein via an opening formed from said step of pivoting said first side wall.
